(19) United States
(12) Patent Application Publication
(10) Pub. No.: US 2012/0210628 A1
(43) Pub. Date: Aug. 23, 2012

(54) Insect Trapping Apparatus and Method of Use Thereof

(76) Inventors: Jee Sun Park, Duluth, GA (US); Myung Soon Park, Duluth, GA (US)

(21) Appl. No.: 13/029,288

(22) Filed: Feb. 17, 2011

(51) Int. Cl. A01M 1/14

(52) U.S. Cl. 43/114

(57) ABSTRACT

An apparatus for trapping insects, such as bedbugs, that are attempting to access beds and other pieces of furniture, the insect trapping apparatus has an adhesive surface that peripherally encircles an inner non-adhesive supporting surface. Users of the insect trapping apparatus place the support posts of beds or other pieces of furniture on the inner non-adhesive supporting surface. The insect trapping apparatus has an outer non-adhesive surface that peripherally encircles the adhesive surface, and the outer non-adhesive surface has channels therethrough with openings to the adhesive surface to permit transit of insects from outside the insect trapping apparatus to the adhesive surface.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to an insect trapping apparatus, and more specifically to an insect trapping apparatus that prevents bed bugs or other insects from accessing the supporting posts of beds or other pieces of furniture.

1. Description of Related Art

Bed bugs and other parasites have affected and attacked humans for centuries. The adverse health affects and the general discomfort caused by such parasites has been a constant issue. Unfortunately, despite our best efforts, such parasites continue to defy our defenses against them.

To address this issue, initially a plain sticky paper was placed in the open to try to trap insects. A problem with this approach is that the user would need to avoid the sticky paper getting stuck to nearby objects, or from stepping on the paper themselves. Another problem was that, when the user handled the sticky paper, the user would need to come into contact with the insects trapped on the paper.

To solve this problem devices were made that enclosed the sticky paper with a small opening. Insects that happened to enter the device were then trapped by the sticky paper. However, the insect would need to seek out the device itself and as a result such devices had limited usefulness.

Another attempt to trap insects involved placing numerous devices in a line that the insects would traverse. The hope here was that, with intelligent placing of the devices, the insects would be forced to traverse at least one device and hopefully get trapped. A problem with this approach is that it is not always easy to define where an insect will be traveling. A further problem is that at least one of the devices could get accidently displaced, thus breaking up the line of devices.

Another attempt involved affixing insect traps on walls, thus lessening the chance of the devices being displaced. However, these devices experienced the above described problem of the insect having to move into the traps that were placed on walls or other non-floor locations.

Another attempt involved placing food or other incentives that would attract the insects to the device.

Although this was moderately more successful, once again the insects needed to be in the vicinity of the device for there to even be a chance of the insect being trapped by the device, and there was no guarantee that the device would prevent all the insects from entering a designated area.

Therefore, it is readily apparent that there is a need for an apparatus that prevents insects, particularly bedbugs, from accessing certain protected areas, such as beds, by providing defenses at the insects' entry avenues to such areas.

### BRIEF SUMMARY OF THE INVENTION

Briefly described, in a preferred embodiment, the present invention overcomes the above-mentioned disadvantages and meets the recognized need for such a device by providing an apparatus for trapping bedbugs that are attempting to access beds and other pieces of furniture. The insect trapping apparatus has an adhesive surface that peripherally encircles an inner non-adhesive supporting surface. Users of the insect trapping apparatus place the support posts of beds or other pieces of furniture on the inner non-adhesive supporting surface. The insect trapping apparatus has an outer non-adhesive surface that peripherally encircles an exposed portion of an adhesive sheet, and the outer non-adhesive surface has channels therethrough with openings to the exposed portion to permit transit of insects from outside the insect trapping apparatus to the exposed portion of the adhesive sheet.

According to its major aspects and broadly stated, the present invention in its preferred form is an insect trapping apparatus comprising a first non-adhesive component, an adhesive sheet having an exposed adhesive portion, wherein the exposed adhesive portion is completely encircled by the first non-adhesive component, and a second non-adhesive component, wherein the second non-adhesive component is completely encircled by the exposed adhesive portion.

The first non-adhesive component comprises a top, a center and a bottom, wherein the top is disposed above the adhesive sheet. The first non-adhesive component comprises an outer peripheral edge, an inner exposed edge, a circular inner exposed edge, and at least one tubular channel diagonally-disposed below the top within the center.

The second non-adhesive component comprises a non-crushing material, and further comprises a head, a foot, a middle and a circular periphery.

The head portion is disposed above the adhesive sheet, wherein the adhesive sheet is disposed below the foot and the bottom, and secured thereto, and wherein the adhesive sheet extends substantially to the outer peripheral edge.

The first non-adhesive component comprises an outer peripheral edge, an inner exposed edge, a top and at least one tubular channel disposed below the top, wherein the tubular channel is diagonally-disposed between and connecting the outer peripheral edge and the inner exposed edge, particularly on a line between pairs of corners of the first non-adhesive component.

The adhesive sheet is generally coplanar with the first non-adhesive component and the second non-adhesive component, wherein the adhesive sheet extends substantially to the outer peripheral edge.

In use, the insect trapping apparatus is placed in a selected location, a supporting post of a bed is subsequently placed on the second non-adhesive adhesive component, and insects are permitted to migrate through the first non-adhesive component to the exposed portion via the generally tubular channels. Subsequently, the insect trapping apparatus is removed and discarded after the insect trapping apparatus has trapped the insects. Next, a new insect trapping apparatus is placed under the supporting post.

Alternatively, the insect trapping apparatus comprises an adhesive sheet having an exposed portion and a non-adhesive component, wherein the non-adhesive component is enclosed by the exposed portion, and wherein the non-adhesive component comprises a non-crushing material, and wherein the non-adhesive component comprises a head, a foot, a middle and a periphery, and wherein the adhesive sheet is secured below and to the foot.

More specifically, the present invention is an insect trapping apparatus comprising a first non-adhesive component, an adhesive sheet and a second non-adhesive component, wherein the first non-adhesive component comprises a top, a bottom, an inner exposed edge and a center, and wherein the adhesive sheet comprises an exposed portion, and wherein the second non-adhesive component comprises a head, a foot, a middle and a periphery. The center comprises generally tubular channels.

The first non-adhesive component further comprises an outer peripheral edge, wherein the outer peripheral edge comprises a first corner, a second corner, a third corner, a fourth corner, a first edge, a second edge, a third edge and a fourth edge, wherein the first edge is distinct from the second edge with the second corner delimiting the first edge and the second edge. Similarly, the third corner delimits the second edge and the third edge, the fourth corner delimits the third edge and the fourth edge, and the first corner delimits the fourth edge and the first edge. It will be recognized by those skilled in the art that, in an alternate embodiment, the first edge, the second edge, the third edge, and the fourth edge, could comprise a single continuous edge with no corners delimiting or separating them.

The adhesive sheet comprises a backing sheet having disposed on the surface thereof any substance that adheres or sticks to insects or foreign objects, wherein the adhesive sheet comprises a viscous liquid or gel. It will be recognized by those skilled in the art that the adhesive sheet could be a flexible sheet, or, alternatively, could comprise a rigid or generally rigid sheet.

The first non-adhesive component and the second non-adhesive component comprise any substance that does not naturally stick to other objects. However, the first non-adhesive component and the second non-adhesive component may stick to other sticky surfaces when placed into contact with such sticky surfaces. The first non-adhesive component and the second non-adhesive component comprise any substance that does not have a tendency to stick to insects or other objects.

The adhesive sheet is disposed below the bottom of the first non-adhesive sheet and is adhered thereto. The second non-adhesive component is secured to the adhesive sheet, wherein the adhesive sheet is secured to the foot of the second non-adhesive component.

The first non-adhesive component and the second non-adhesive component are secured to the adhesive sheet, wherein the adhesive sheet is adhesively secured to the bottom, and wherein the adhesive sheet extends below the first non-adhesive component and the second non-adhesive component to approximately the outer peripheral edge, and wherein the adhesive sheet is adhesively secured to the foot.

The inner exposed edge and/or the periphery are circular. It will be recognized by those skilled in the art that the inner exposed edge and/or the periphery could comprise any shape. The generally tubular channels are disposed between the outer peripheral edge and the inner exposed edge, wherein the generally tubular channels are directionally oriented. The generally tubular channels extend directionally from at least two of the opposing corners.

In the preferred embodiment the exposed portion of the adhesive sheet is completely enclosed by the first non-adhesive component and the second non-adhesive component is completely enclosed by the exposed portion. The first non-adhesive component is disposed above the adhesive sheet.

In a further alternative, the periphery comprises a shape dimensioned to match the shape of the supporting post disposed on the head of the second non-adhesive component.

In the preferred embodiment, the inner exposed edge is distinct from the outer peripheral edge. In an alternate embodiment, the first non-adhesive component does not completely enclose the exposed surface of the adhesive sheet and the inner exposed edge is contiguous with at least a portion of the first edge. It will be recognized by those skilled in the art that the inner exposed edge could be contiguous with portions of the second, third and fourth edges.

The generally tubular channels are disposed within the center of the first non-adhesive component, wherein the generally tubular channels comprise a generally sinusoidal shape. Alternately, the generally tubular channels comprise circular tubes. In a further alternative, the generally tubular channels comprise triangular tubes, rectangular tubes or any other tubular profile. In yet a further alternative, the generally tubular channels comprise more than one of the aforementioned shapes, or any variation or combination thereof. The generally tubular channels open at the inner exposed edge and at the outer peripheral edge, wherein the generally tubular channels provide an open path from the outer peripheral edge to the inner exposed edge.

In the preferred embodiment, the second non-adhesive component comprises a non-crushing material, thereby preventing or ameliorating any adverse effects to the functionality of the insect trapping apparatus caused by the insect trapping apparatus supporting the bed or similar furniture objects for which protection is desired. That is, the second non-adhesive component comprises any material that does not deform when weight of the bed is placed on it.

In a preferred embodiment, the first non-adhesive component is approximately coplanar with the adhesive sheet and the adhesive sheet is approximately coplanar with the second non-adhesive component.

In use, the supporting posts of bed are placed on a plurality of insect trapping apparatuses, each supporting a post on a single insect trapping apparatus, wherein the supporting posts are placed on the second non-adhesive component. The supporting post is placed on the second non-adhesive component, wherein the supporting post is disposed in contact with the head of the second non-adhesive component. It will be recognized that any piece of furniture or object having legs or other supporting posts may be placed on the second non-adhesive component.

When insects attempt to access the post, insects are trapped on the exposed portion of the adhesive sheet. Some insects navigate to the exposed portion of the adhesive sheet via the generally tubular channels, while other insects navigate to the exposed portion of the adhesive sheet via the top of the first non-adhesive component. Insects are trapped on the exposed portion of the adhesive sheet by coming into contact with the exposed portion, wherein once contact is initiated, the insects adhere to the exposed portion and are unable to escape from the exposed portion.

After capturing and retaining the insects, the insect trapping apparatuses are removed and discarded. New insect trapping apparatuses are subsequently placed under the supporting posts.

In an alternate embodiment, the insect trapping apparatus comprises the adhesive sheet and the second non-adhesive component, but does not comprise the first non-adhesive component, wherein the first non-adhesive component is present in the preferred embodiment.

Accordingly, a feature and advantage of the present invention is its ability to prevent insects from accessing high priority insect-free areas such as beds.

Another feature and advantage of the present invention is its ability to be placed out of the paths of normal human traffic.

Still another feature and advantage of the present invention is its ability to be easily replaced without the consumer being forced to come into contact with the adhesive or trapped insects.

Yet another feature and advantage of the present invention is its ability to be placed in numerous and diverse locations.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of four apparatuses according to a preferred embodiment, shown in use protecting a bed;

FIG. 2 is a detail perspective view of an apparatus according to the preferred embodiment of FIG. 1, shown in use protecting a bed post;

FIG. 3 is a detail perspective view of an apparatus according an alternate embodiment, shown in use protecting a bed post;

FIG. 4 is a top view of an apparatus according to the preferred embodiment of FIG. 1; and

FIG. 5 is a perspective view of an apparatus according to the preferred embodiment of FIG. 1, with detail breakout depicting subsurface channels.

### DETAILED DESCRIPTION OF THE PREFERRED AND SELECTED ALTERNATE EMBODIMENTS OF THE INVENTION

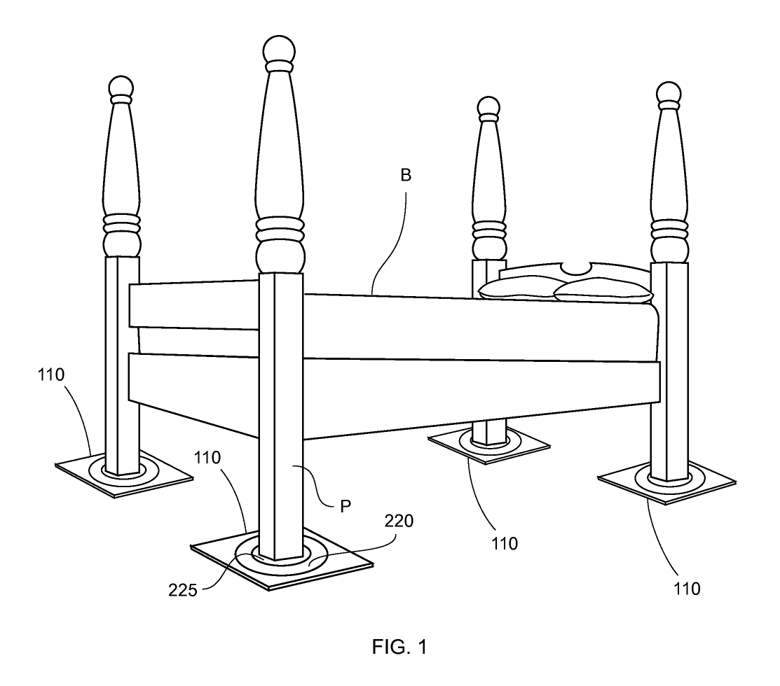

In describing the preferred and selected alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

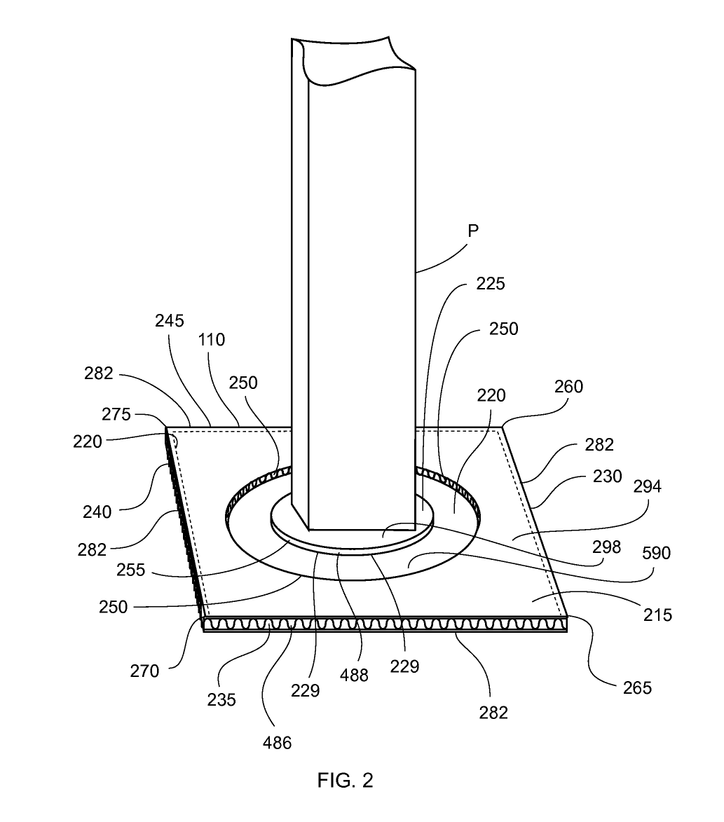

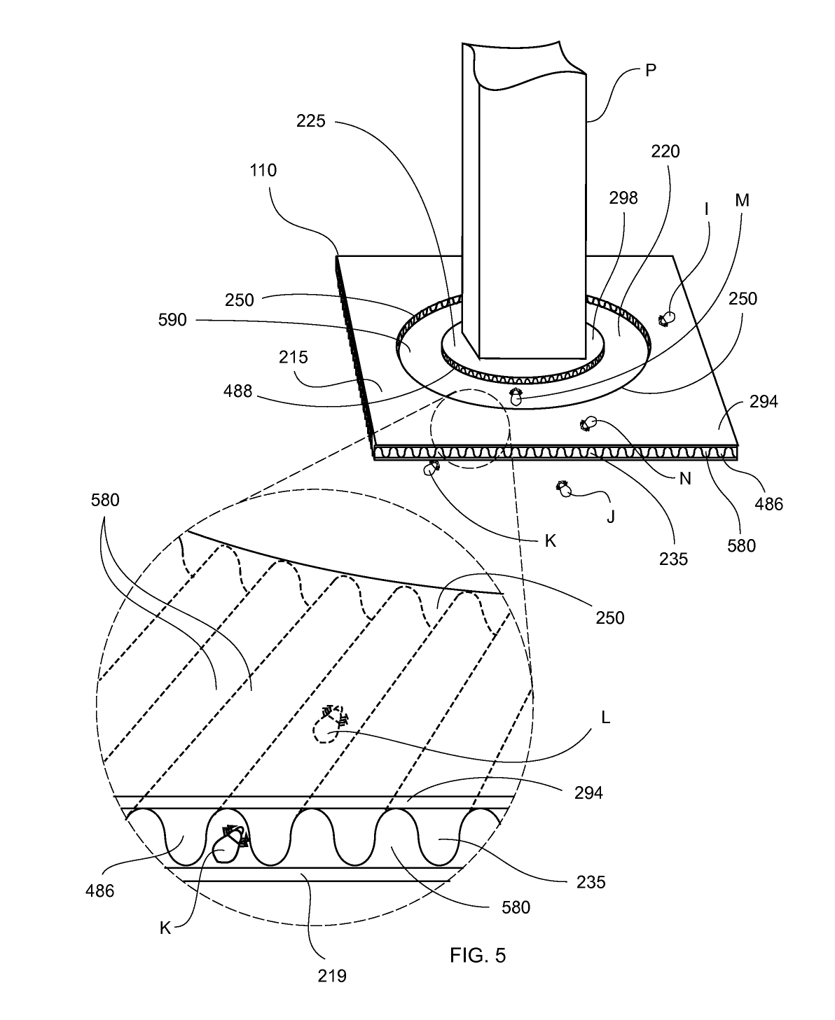

Referring now to FIGS. 1, 2, 4 and 5, illustrated therein is a preferred embodiment of insect trapping apparatus 110, wherein insect trapping apparatus 110 comprises first non-adhesive component 215, adhesive sheet 220 and second non-adhesive component 225, and wherein first non-adhesive component 215 comprises top 294, bottom 219, inner exposed edge 250 and center 486 (best shown in FIGS. 2 and 5), and wherein adhesive sheet 220 comprises exposed portion 590, and wherein second non-adhesive component 225 comprises head 298, foot 229, middle 255 and periphery 488 (best shown in FIGS. 2 and 5). Center 486 comprises generally tubular channels 580.

First non-adhesive component 215 further comprises outer peripheral edge 282, wherein outer peripheral edge 282 comprises first corner 260, second corner 265, third corner 270, fourth corner 275, first edge 230, second edge 235, third edge 240 and fourth edge 245, wherein first edge 230 is preferably distinct from second edge 235 with second corner 265 delimiting first edge 230 and second edge 235. Similarly, third corner 270 delimits second edge 235 and third edge 240, fourth corner 275 delimits third edge 240 and fourth edge 245, and first corner 260 delimits fourth edge 245 and first edge 230. It will be recognized by those skilled in the art that, in an alternate embodiment, first edge 230, second edge 235, third edge 240, and fourth edge 245, could comprise a single continuous edge with no corners delimiting or separating them.

Adhesive sheet 220 preferably comprises a backing sheet (not shown) having disposed on the surface thereof any substance that adheres or sticks to insects or foreign objects, wherein adhesive sheet 220 preferably comprises a viscous liquid or gel. It will be recognized by those skilled in the art that adhesive sheet 220 could be a flexible sheet, or, alternatively, could comprise a rigid or generally rigid sheet.

First non-adhesive component 215 and second non-adhesive component 225 preferably comprise any substance that does not naturally stick to other objects. However, first non-adhesive component 215 and second non-adhesive component 225 may stick to other sticky surfaces when placed into contact with such sticky surfaces. First non-adhesive component 215 and second non-adhesive component 225 comprise any substance that does not have a tendency to stick to insects or other objects.

Adhesive sheet 220 is disposed below bottom 219 and is adhered thereto. Second non-adhesive component 225 is secured to adhesive sheet 220, wherein adhesive sheet 220 is secured to foot 229 of second non-adhesive component 225.

First non-adhesive component 215 and second non-adhesive component 225 are secured to adhesive sheet 220, wherein adhesive sheet 220 is adhesively secured to bottom 219, and wherein adhesive sheet 220 extends below first non-adhesive component 215 and second non-adhesive component 225 to approximately outer peripheral edge 282, and wherein adhesive sheet 220 is adhesively secured to foot 229.

Inner exposed edge 250 and/or periphery 488 are preferably circular. It will be recognized by those skilled in the art that inner exposed edge 250 and/or periphery 488 could comprise any shape. Generally tubular channels 580 are preferably disposed between outer peripheral edge 282 and inner exposed edge 250, wherein generally tubular channels 580 are directionally oriented. Generally tubular channels 580 extend generally directionally from at least two of opposing corners 260, 270 or 265, 275.

In the preferred embodiment, exposed portion 590 is completely enclosed by first non-adhesive component 215 and second non-adhesive component 225 is completely enclosed by exposed portion 590. First non-adhesive component 215 is preferably disposed above adhesive sheet 220.

In a further alternative, periphery 488 comprises a shape dimensioned to match the shape of supporting post P disposed on head 298.

In the preferred embodiment inner exposed edge 250 is distinct from outer peripheral edge 282. In an alternate embodiment, first non-adhesive component 215 does not completely enclose exposed surface 590 of adhesive sheet 220 and inner exposed edge 250 is contiguous with at least a portion of first edge 230. It will be recognized by those skilled in the art that inner exposed edge 250 could be contiguous with portions of additional edges 235, 240 and/or 245.

Generally tubular channels 580 are disposed within center 486 of first non-adhesive component 215, wherein generally tubular channels 580 preferably comprise the sinusoidal shape shown in FIG. 5. Alternately, generally tubular channels 580 comprise circular tubes. In a further alternative, generally tubular channels 580 comprise triangular tubes, rectangular tubes or any other tubular profile. In yet a further alternative, generally tubular channels 580 comprise more than one of the aforementioned shapes, or any variation or combination thereof. Generally tubular channels 580 open at inner exposed edge 250 and at outer peripheral edge 282, wherein generally tubular channels 580 provide an open path from outer peripheral edge 282 to inner exposed edge 250.

In the preferred embodiment, second non-adhesive component 225 preferably comprises a non-crushing material, thereby preventing or ameliorating any adverse effects to the functionality of insect trapping apparatus 110 caused by insect trapping apparatus 110 supporting bed B or similar furniture objects for which protection is desired. That is, second non-adhesive component 225 comprises any material that does not deform when weight of bed B is placed on it.

In the preferred embodiment, first non-adhesive component 215 is preferably approximately coplanar with adhesive sheet 220 and adhesive sheet 220 is preferably approximately coplanar with second non-adhesive component 225.

Returning now more particularly to FIG. 1, in use, supporting posts P of bed B are preferably placed on a plurality of insect trapping apparatuses 110, each supporting post P on a single insect trapping 110, wherein supporting posts P are preferably placed on second non-adhesive component 225. Turning now to FIG. 2, supporting post P is preferably placed on second non-adhesive component 225, wherein supporting post P is disposed in contact with head 298. It will be recognized that any piece of furniture or object having legs or other supporting posts P may be placed on second non-adhesive component 225.

When insects I, J, K, L, M, and N attempt to access post P (best shown in FIG. 5), insects I, J, K, L, M, and N are preferably trapped on exposed portion 590 of adhesive sheet 220 (best shown by insect M in FIG. 5). Insects J and K navigate to exposed portion 590 of adhesive sheet 220 via generally tubular channels 580 (best shown by insect L in FIG. 5), or, alternatively, insects J and K navigate to exposed portion 590 of adhesive sheet 220 via top 294 (best shown by insects I and N in FIG. 5). Insects I, J, K, L, M, and N are preferably trapped on exposed portion 590 of adhesive sheet 220 by coming into contact with exposed portion 590 of adhesive sheet 220, wherein once contact is initiated, insects I, J, K, J, M, and/or N preferably adhere to exposed portion 590 and are unable to escape from exposed portion 590.

After capturing and retaining insects I, J, K, L, M, and/or N, insect trapping apparatuses 110 are removed and discarded. New insect trapping apparatuses 110 are subsequently placed under supporting posts P.

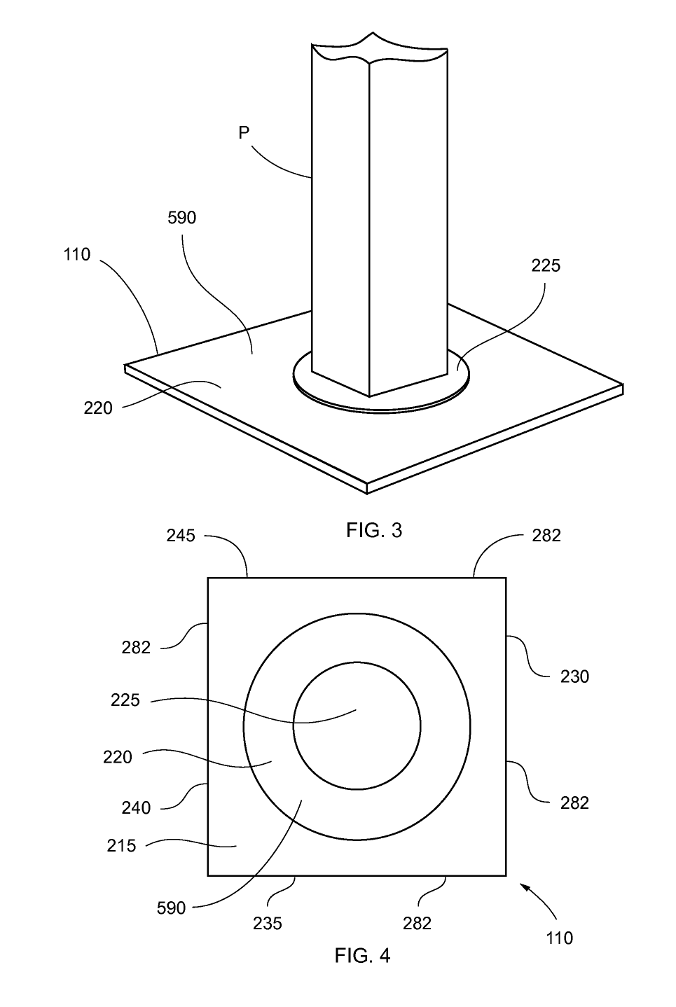

Referring now more specifically to FIG. 3, illustrated therein is an alternate embodiment of insect trapping apparatus 110, wherein the alternate embodiment of FIG. 3 is substantially equivalent in form and function to that of the preferred embodiment detailed and illustrated in FIGS. 1, 2, 4, and 5, except as hereinafter specifically referenced. Specifically, the embodiment of FIG. 3, comprises adhesive sheet 220 and second non-adhesive component 225, but does not comprise first non-adhesive component 215, wherein first non-adhesive component 215 is present in the embodiments described in FIGS. 1, 2, 4, and 5.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. An insect trapping apparatus comprising:
a first non-adhesive component, wherein said first non-adhesive component comprises at least one tubular channel;
an adhesive sheet, wherein said adhesive sheet comprises an exposed adhesive portion, and wherein said exposed adhesive portion is completely encircled by said first non-adhesive component; and
a second non-adhesive component, wherein said second non-adhesive component is completely encircled by said exposed adhesive portion.

2. The insect trapping apparatus of claim 1, wherein said first non-adhesive component comprises a top, a center and bottom, and wherein said top is disposed above said adhesive sheet.

3. The insect trapping apparatus of claim 2, wherein said first non-adhesive component comprises an outer peripheral edge, and wherein said first non-adhesive component comprises an inner exposed edge, and wherein said at least one tubular channel is diagonally disposed below said top within said center.

4. The insect trapping apparatus of claim 3, wherein said second non-adhesive component comprises a non-crushing material.

5. The insect trapping apparatus of claim 4, wherein said second non-adhesive component comprises a head, a foot, a middle and a circular periphery.

6. The insect trapping apparatus of claim 5, wherein said first non-adhesive component comprises a circular inner exposed edge.

7. The insect trapping apparatus of claim 6, wherein said adhesive sheet is generally coplanar with said first non-adhesive component, and wherein said adhesive sheet is generally coplanar with said second non-adhesive component.

8. The insect trapping apparatus of claim 7, wherein said head portion is disposed above said adhesive sheet.

9. The insect trapping apparatus of claim 8, wherein said adhesive sheet is disposed below, and secured to, said foot and said bottom, and wherein said adhesive sheet extends substantially to said outer peripheral edge.

10. The insect trapping apparatus of claim 1, wherein said first non-adhesive component comprises an outer peripheral edge, and wherein said first non-adhesive component comprises an inner exposed edge, and wherein said first non-adhesive component comprises a top and at least one tubular channel disposed below said top.

11. The insect trapping apparatus of claim 10, wherein said at least one tubular channel is diagonally disposed between pairs of corners of said first non-adhesive component.

12. The insect trapping apparatus of claim 10, wherein said adhesive sheet is generally coplanar with said first non-adhesive component, and wherein said adhesive sheet is generally coplanar with said second non-adhesive component, and wherein said adhesive sheet extends substantially to said outer peripheral edge.

13. A method of trapping insects, said method comprising the steps of:
providing an insect trapping apparatus comprising a first non-adhesive component with generally tubular channels therewithin, a second non-adhesive component and an adhesive sheet having an exposed portion when said adhesive sheet is secured to said first non-adhesive component, wherein said first non-adhesive adhesive component completely encircles said exposed portion, and wherein said second non-adhesive adhesive component is completely encircled by said exposed portion;
placing said insect trapping apparatus in a selected location;
placing a supporting post of a bed on said second non-adhesive adhesive component; and
permitting insects to migrate through said first non-adhesive component to said exposed portion via said generally tubular channels.

14. The method of claim 13, further comprising the steps of:
removing said insect trapping apparatus; and
discarding said insect trapping apparatus after said insect trapping apparatus has trapped insects.

15. The method of claim 14, further comprising the step of:
placing a new insect trapping apparatus under the supporting post.

16. The method of claim 13, wherein said first non-adhesive component has an outer peripheral edge, and wherein said first non-adhesive component has an inner exposed edge, and wherein said method further comprises the step of:
connecting said outer peripheral edge to said inner exposed edge with generally tubular channels.

17. The method of claim 13, wherein said first non-adhesive component has an outer peripheral edge, and wherein said first non-adhesive component has an inner exposed edge, and wherein said method further comprises the step of:
connecting said outer peripheral edge to said inner exposed edge with diagonally-oriented tubular channels.

18. An insect trapping apparatus comprising:
an adhesive sheet having an exposed portion; and
a non-adhesive component, wherein said non-adhesive component is enclosed by said exposed portion.

19. The insect trapping apparatus of claim 18, wherein said non-adhesive component comprises a non-crushing material.

20. The insect trapping apparatus of claim 19, wherein said non-adhesive component comprises a head, a foot, a middle and a periphery, and wherein said adhesive sheet is secured below and to said foot.
